(19) United States
(12) Patent Application Publication
(10) Pub. No.: US 2003/0212542 A1
(43) Pub. Date: Nov. 13, 2003

(54) Platform-independent automated machine translation system

(75) Inventors: Kevin Akira Lee, Cerritos, CA (US); Rina Horiuchi, Old Greenwich, CT (US); Christopher S. Hong, Potomac, MD (US)

Correspondence Address: BINGHAM, MCCUTCHEN LLP, THREE EMBARCADERO, SUITE 1800, SAN FRANCISCO, CA, 94111-4067, US

(73) Assignee: Amikai, Inc.

(21) Appl. No.: 10/142,355

(22) Filed: May 8, 2002

(51) Int. Cl. G06F 17/28

(52) U.S. Cl. 704/7

(57) ABSTRACT

A client computer program designed to run in operating systems with various primary character sets is provided. The client computer program further allows the user to choose a preferred destination for translated documents. For example, the translation can be appended to the original document, written into a new document, sent to the clipboard, or turned out to any other supported destination according to the specifications of the user. In addition, the client computer program provides a translation job queue window that lists documents awaiting analysis and transmission for translation. Through the translation job queue window, the user can dynamically add to and delete from the translation job queue, as well as suspend or reorder jobs, and open completed files directly from the list. Furthermore, the user can choose to display either the requested translation alone or the requested translation together with the untranslated email message in the same window. Finally, the client computer program interacts with an email program so that the user can initiate translation directly from the email program's user interface.

### BACKGROUND OF THE INVENTION

1. Field of the Invention

The present invention relates generally to computer systems and, particularly, to automated translation systems.

2. Related Art

When purchasing, installing, and running current machine translation software users must take care of selecting a version of the software that matches the primary character encoding of the operating system running on the user's computer.

Furthermore, when a user performs a translation using current machine translation software, the destination of the translation can be one of many locations. In some packages, the translation is appended to the original document. In some packages, the translation goes into a new document. In some packages, the translation is copied onto the clipboard. Current systems, however, do not allow the user to select a destination for the translation.

Additionally, when a user wishes to translate more than one document at a time, some machine translation software packages require the user to wait until the completion of one translation before initiating the translation of another document. In other packages, the user can queue up translation jobs to be performed. Once a job enters the queue, however, the user can no longer modify it. As a result, the user is unable to cancel a job, or reorder the priority of jobs once the translation request is made.

Finally, when a user wants to translate a received email message, he or she must currently cut and paste the text into a text translator. This is slow and inconvenient. In addition, the user must decide where to store the result of the translation of the email. The user can store the translation in a file or in a new email message, however the translation will not be clearly and immediately connected with the original email message, thus the translated version will be prone to loss without the user investing considerable effort and care to create an organized library of messages and files. Furthermore, the user is not able to choose to display in a single window the original and translated versions of the message. Finally, when composing email that the user would like to translate before sending, the user must copy and paste the translation results from the machine translation software into the email composition window, a slow and inconvenient process.

### SUMMARY OF THE INVENTION

The system and method of the present invention provide a client computer program designed to run in operating systems with various primary character sets. As a result, languages with primary character sets not supported by the underlying OS or application are handled by the client computer program, and all languages regardless of primary character set are handled through a uniform user interface.

Furthermore, the user is able to choose a preferred destination for translated documents. For example, the translation can be appended to the original document, written into a new document, sent to the clipboard, or turned out to any other supported destination according to the specifications of the user.

In addition, the client computer program provides a translation job queue window that lists documents awaiting analysis and transmission for translation. Furthermore, translated documents are marked as completed and listed in another section of the translation job queue window. Through the translation job queue window, the user can dynamically add to and delete from the translation job queue, as well as suspend or reorder jobs, and open completed files directly from the list.

Furthermore, the client computer program interacts with an email program such as Microsoft Outlook® so that the user can initiate translation directly from the email program's user interface. This eliminates the need to cut and paste text from email messages into a text translator. In addition, in some embodiments of the invention, the user can store the translation of a received email message as an attachment to the original email message. As a result, the translated message is automatically “filed” with the original message for easy retrieval in the future. Furthermore, in some embodiments of the invention, the user can choose to display either the requested translation alone or the requested translation together with the untranslated email message in the same window. Finally, in some embodiments of the invention, the user can translate an outgoing email message and elect to have the resulting translation inserted or attached to the outgoing message, simplifying the message composition process.

### BRIEF DESCRIPTION OF THE DRAWINGS

FIG. 1 is a block diagram illustrating the overall architecture of a computer system, in accordance with some illustrative embodiments of the invention.

FIG. 2 is a block diagram illustrating the architecture of a computer system for downloading the client computer program, in accordance with some illustrative embodiments of the invention.

FIG. 3 is a flow diagram describing the process of downloading the client computer program of FIG. 2.

FIG. 4 is a block diagram illustrating the architecture of a computer system through which a user signs-up for an account on a server-based machine translation service, in accordance with some illustrative embodiments of the invention.

FIG. 5 is a flow diagram describing the process through which a user signs-up for an account on the server-based machine translation service of FIG. 4.

FIG. 6 is a block diagram of the architecture of a computer system through which a user signs-in to use a server-based machine translation service, in accordance with some illustrative embodiments of the invention.

FIG. 7 is a flow diagram describing the process through which a user signs-in to use the server-based machine translation service of FIG. 6.

FIG. 8 is a block diagram of the architecture of a computer system through which a user performs a translation using a server-based machine translation service, in accordance with some illustrative embodiments of the invention.

FIG. 9 is a flow diagram describing the process through which a user performs a translation using the server-based machine translation service of FIG. 8.

FIG. 10 is a block diagram illustrating the overall architecture of a computer system in which a text adapter prepares text output from an application or device for safe transmission, in accordance with some illustrative embodiments of the invention.

FIG. 11 is a flow diagram of the process through which the text adapter of FIG. 10 prepares text output from an application or device for safe transmission.

FIG. 12 is a flow diagram of the process through which a text adapter prepares text input received by an application or device for proper processing by the application or device, in accordance with some illustrative embodiments of the invention.

FIG. 13 is a screenshot showing a destination translation window, in accordance with some illustrative embodiments of the invention.

FIG. 14 is a screenshot showing a translation job queue window, in accordance with some illustrative embodiments of the invention.

FIG. 15 is a screenshot showing how a user can choose the destination of the translation of an incoming email message, in accordance with some illustrative embodiments of the invention.

FIG. 16 is a screenshot showing how a user can select whether to display an original email alone or the original and translation together, in accordance with some illustrative embodiments of the invention.

FIG. 17 is a screenshot showing how a user can choose the destination of the translation of an outgoing email message, in accordance with some illustrative embodiments of the invention.

### DETAILED DESCRIPTION OF THE INVENTION

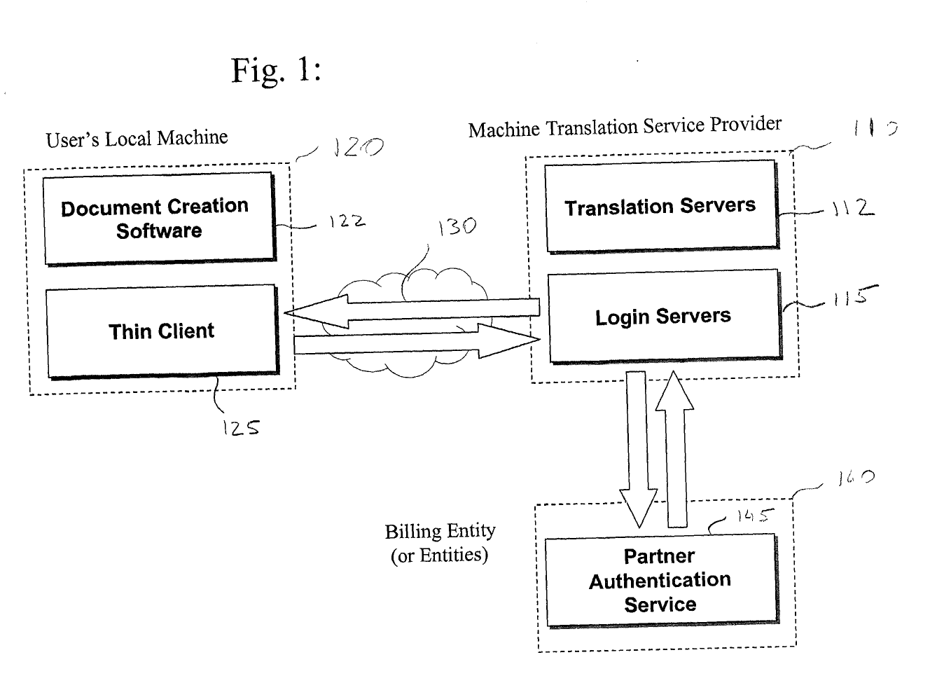

FIG. 1 is a block diagram of the overall architecture of a server-based machine translation service, in accordance with some illustrative embodiments of the invention. A server 110 is connected to one or more client computers 120 via a distributed network 130. On client computer 120 reside one or many document creation software applications 122 and a client computer program 125. In some embodiments of the invention, client computer program 125 is thin (i.e. it requires very little storage space), so that the client computer program 125 can be quickly downloaded onto client computer 120 over distributed computer network 130. Examples of document creation software applications 122 include word processing, email, spreadsheet, or slide presentation software. In some embodiments, client computer program 125 acts as a plug-in to one or more document creation software applications 122, to enable communication of translation requests with the machine translation service's servers 110. In some embodiments, however, client computer program 125 may also operate independently from document creation software applications 122.

Servers 110, in turn, contain machine translation servers 112 and log-in servers 115. Log-in servers 115 handle user account creation and sign-in authentication, communicating with Billing Services and with internal databases. Machine translation servers 112 process machine translation requests submitted by client computer programs 125 on users' client computers 120, and return the translated results to the requesting client computer program 125. Machine translation servers 112 can be any machine translation server known in the art, suitable for use in the present invention. A list of machine translation server providers in provided in Appendix A.

Billing services 145 are optionally internal to the server-based machine translation service provider (not shown), or are 3^{rd} party partners 140 (as shown in FIG. 1).

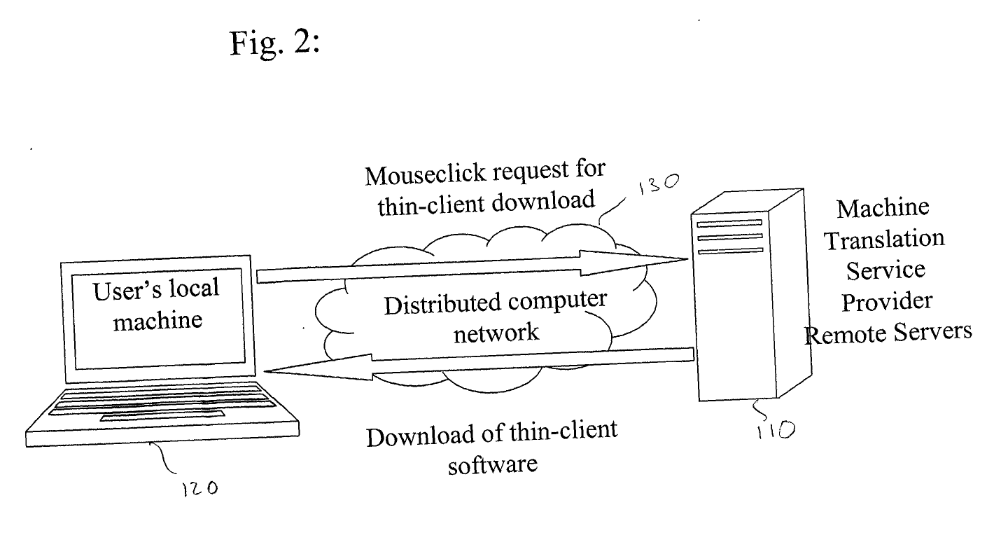

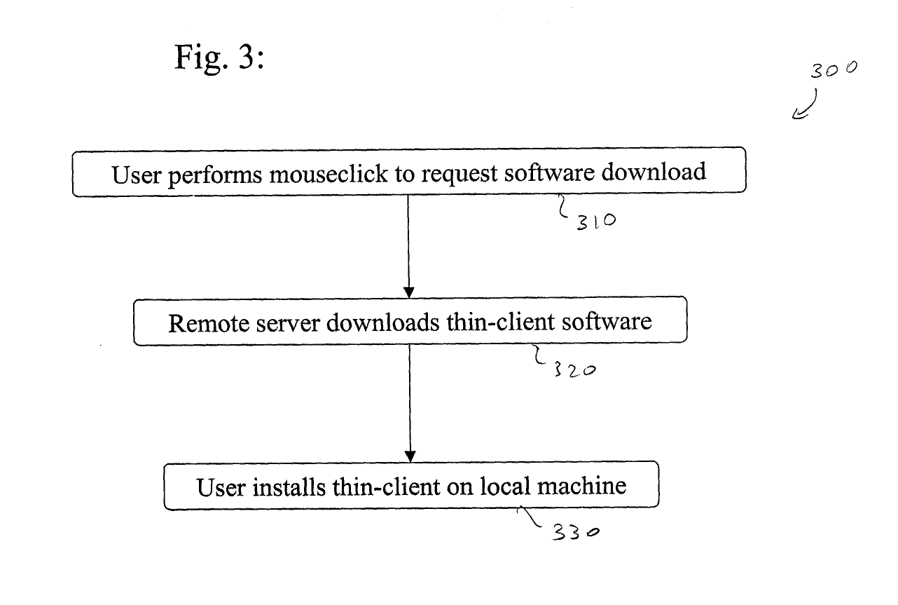

FIGS. 2 and 3 are block and flow diagrams describing a process 300 through which a user downloads the client computer program 125. Initially (stage 310), the user submits a request for client computer program 125 to be downloaded across distributed computer network 130 (e.g. the Internet). In some illustrative embodiments of the invention, this request could take the form of a mouse click in a web browser on a web page offering the client computer program download. Servers 110 receive the request, and immediately (stage 320) begin download of client computer program 125. Since client computer program 125 is provided for free (or for a nominal fee) to the user, there is no need to exchange billing or account information. Downloaded client computer program 125 is then installed on the user's client computer 120 (stage 330).

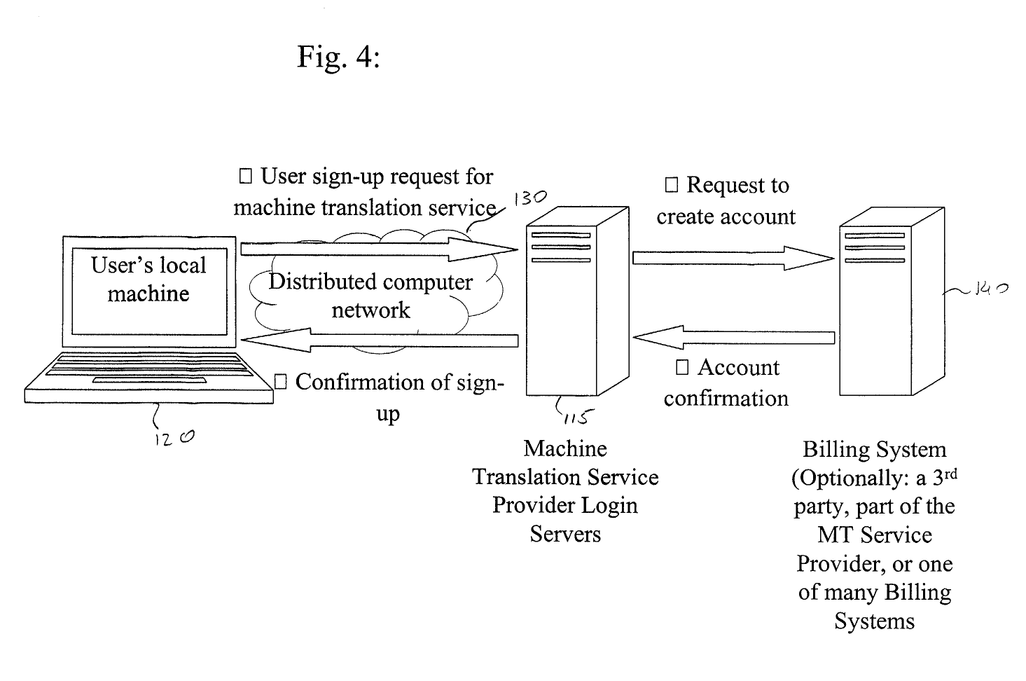

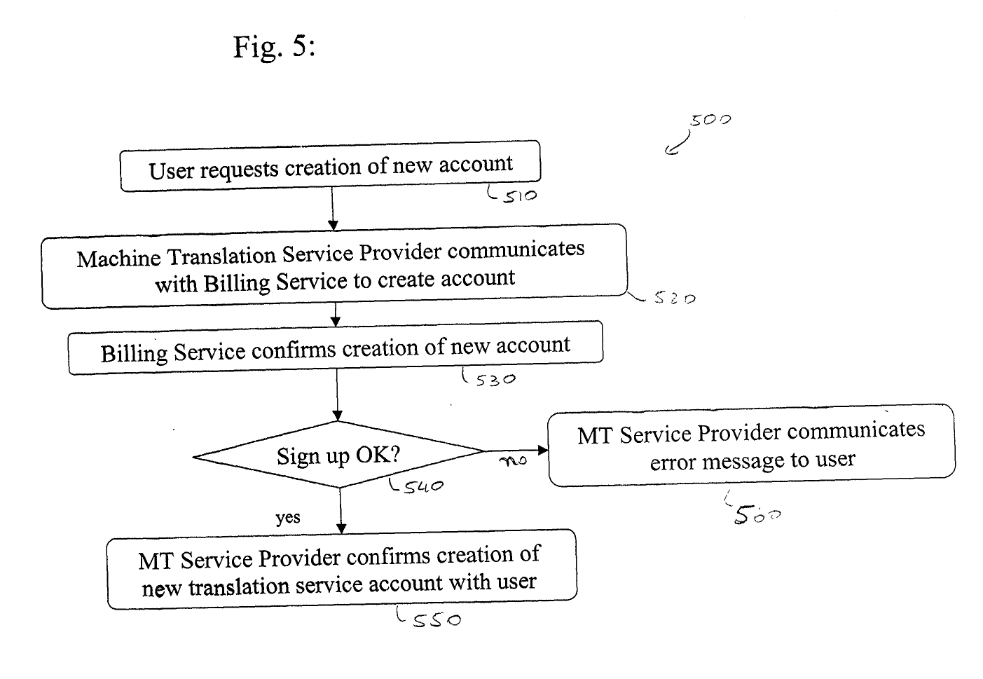

FIGS. 4 and 5 are block and flow diagrams describing a process 500 through which a user signs up for a server-based machine translation service, in accordance with some exemplary embodiments of the invention. Initially (stage 510) the user submits a request for account creation across distributed computer network 130. This request may involve a multi-part process including submission of information such as preferred account name, preferred account password, payment information, or other personal information. Login servers 115 transmit some or all of this information with billing service 140 (stage 520) to complete the account creation transaction (stage 530), including accepting payment and establishing the user account. If billing service 140 is able to create an account for the user (stage 540), login servers 115 are notified so that they may confirm the success of the account creation to the user's client computer 120 (stage 550). Conversely, if billing service 140 is unable to create an account for the user (stage 540), login servers 115 are notified so that they may inform the user through a error message to the user's client computer 120 (stage 560).

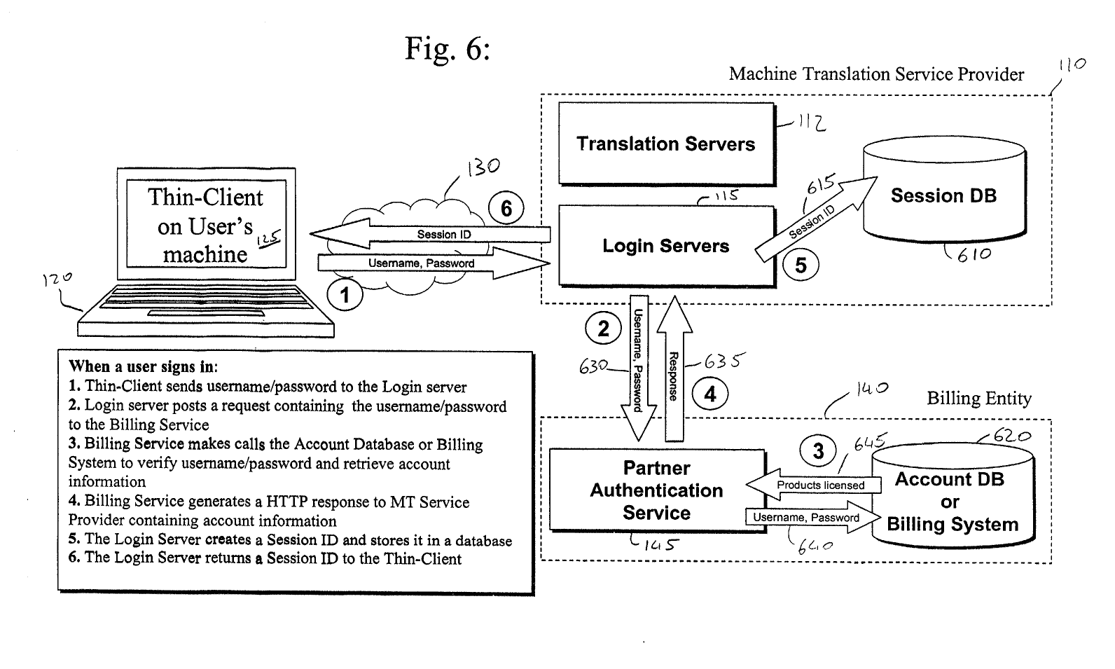

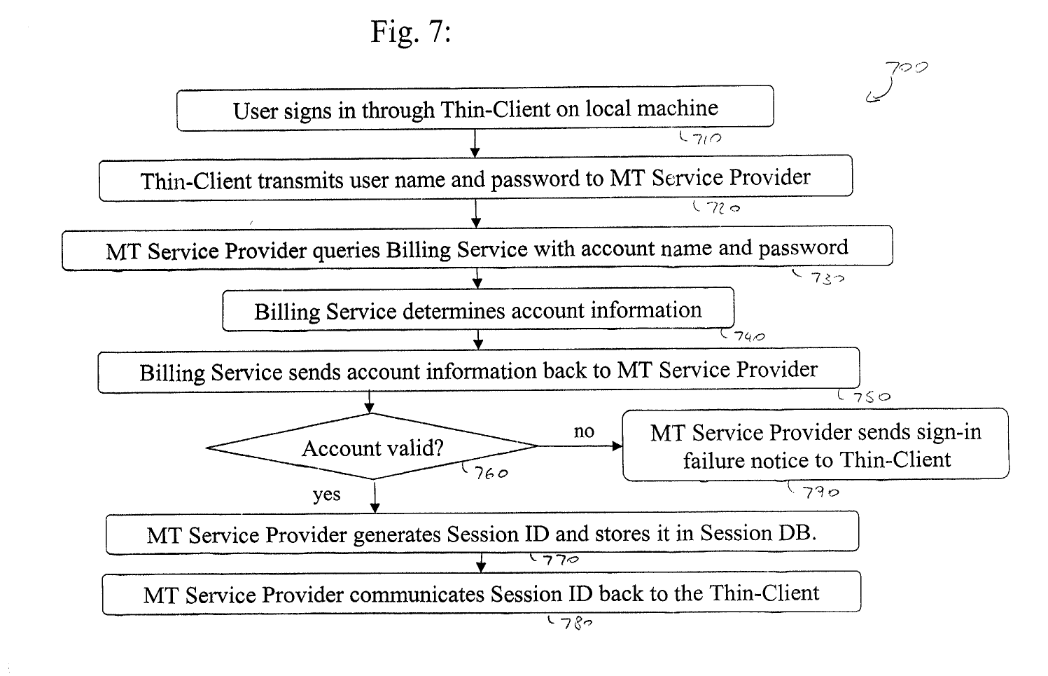

FIGS. 6 and 7 describe a process 700 through which a user signs-in to use the ASP-based Machine Translation Service, in accordance to some exemplary embodiments of the invention. The user initiates the sign-in process through the interface of the client computer program 125 on the user's client computer 120 (stage 710). Client computer program 125, in turn, transmits the user's account information (stage 720), such as account name and password across distributed computer network 130 to login servers 115 on servers 110. Login servers 115 then query billing service 140 with the user's account information 630 (stage 730). Billing service 140 authenticates the account information (stage 740) and communicates an account status 635 back to login servers 115 (stage 750). Billing service 140, in fact, uses partner authentication service 145 to query account database 620 with the user name and password 640 and obtain a response 645. If the account information is not valid (stage 760), login servers 115 communicate this error message back to the client computer program 125 on the user's client computer 120 (stage 790). Conversely, if the account information is valid (stage 760), login servers 115 are notified and a session ID 615 is generated (stage 770), stored in a session database 610, and then transmitted back to client computer program 125 on the user's client computer 120 where it is stored (stage 780).

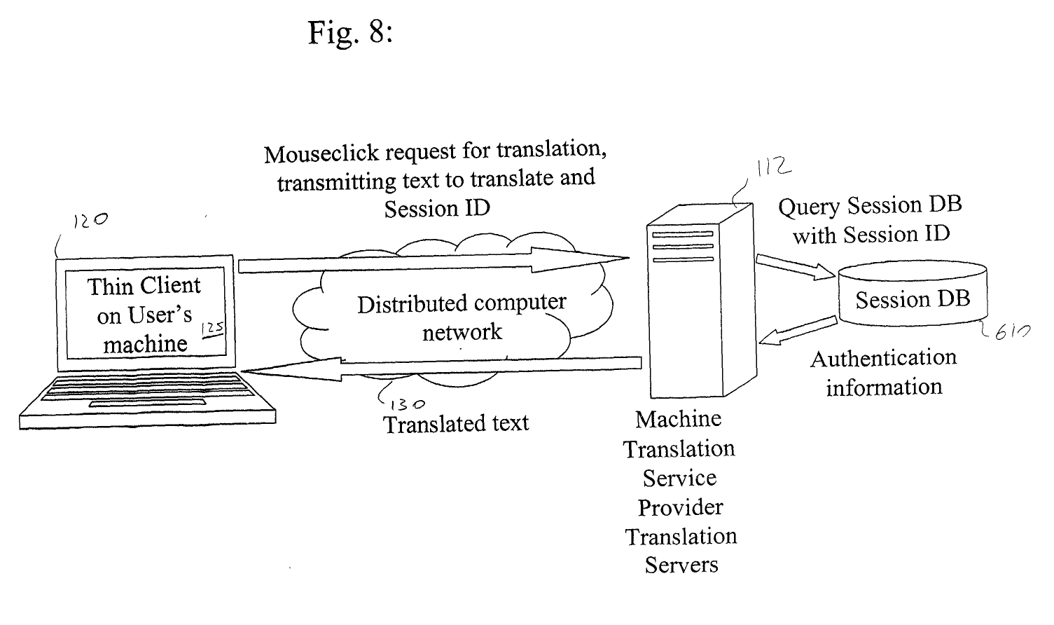

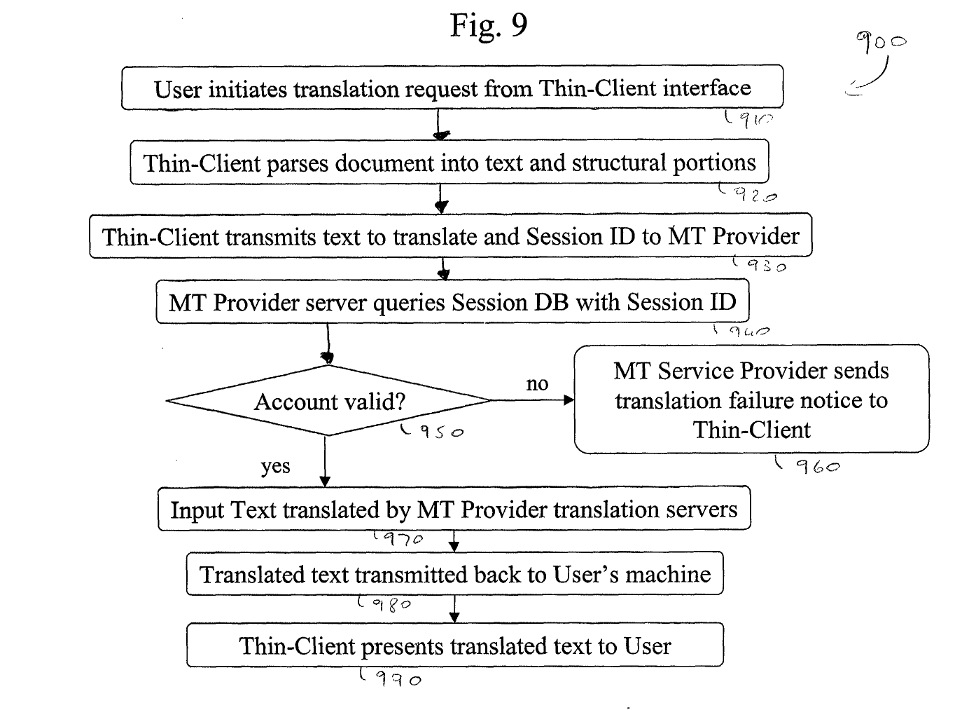

FIGS. 8 and 9 describe a process 900 through which a user submits a translation request to the server-based machine translation service, in accordance with some exemplary embodiments of the invention. The user initiates a translation request (stage 910) either through client computer program 125 running as a plug-in to a content creation software application 122 or through client computer program 125 itself. As discussed in reference to FIG. 1, document creation software 122 can be word processing, email, spreadsheet, slide presentation, or other document creation software. After the initiation of the translation request, client computer program 125 parses the text to translate from the document structure and saves the structural information about the document (stage 920). The plain-text is then communicated along with session ID 615 across distributed computer network 130 to the one or more translation servers 112 on servers 110 (stage 930). Session ID 615 is checked against the information stored in session DB 610 (stage 940). If session ID 615 is not valid (stage 950), the failure is reported back to the client computer program 125 on the user's client computer 120 (stage 960). Conversely, if session ID 615 is valid (stage 950), translation servers 122 translate the submitted text (stage 970), and return the translated output text to client computer program 125 on the user's client computer 120 (stage 980). Client computer program 125 then reassembles the translated text into the saved document structure to create a translated version of the original, richly-structured document (stage 990).

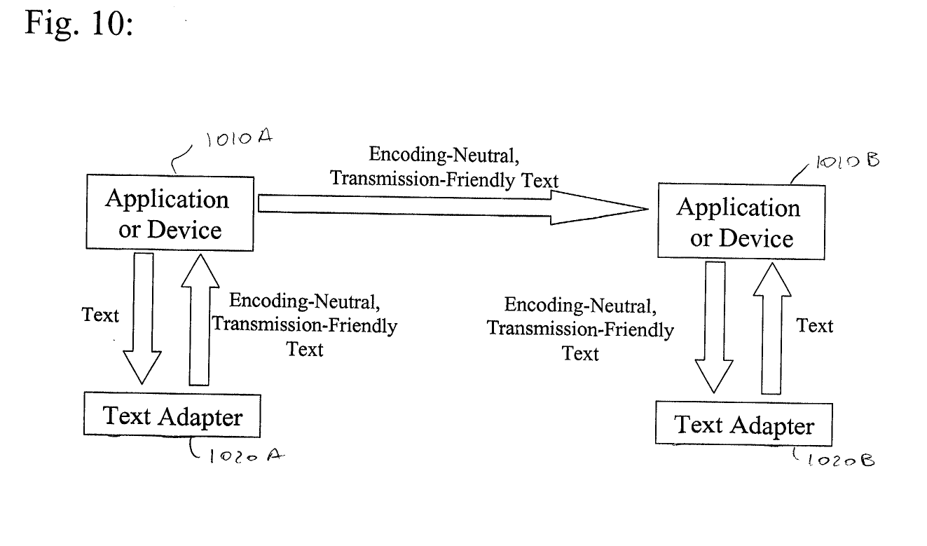

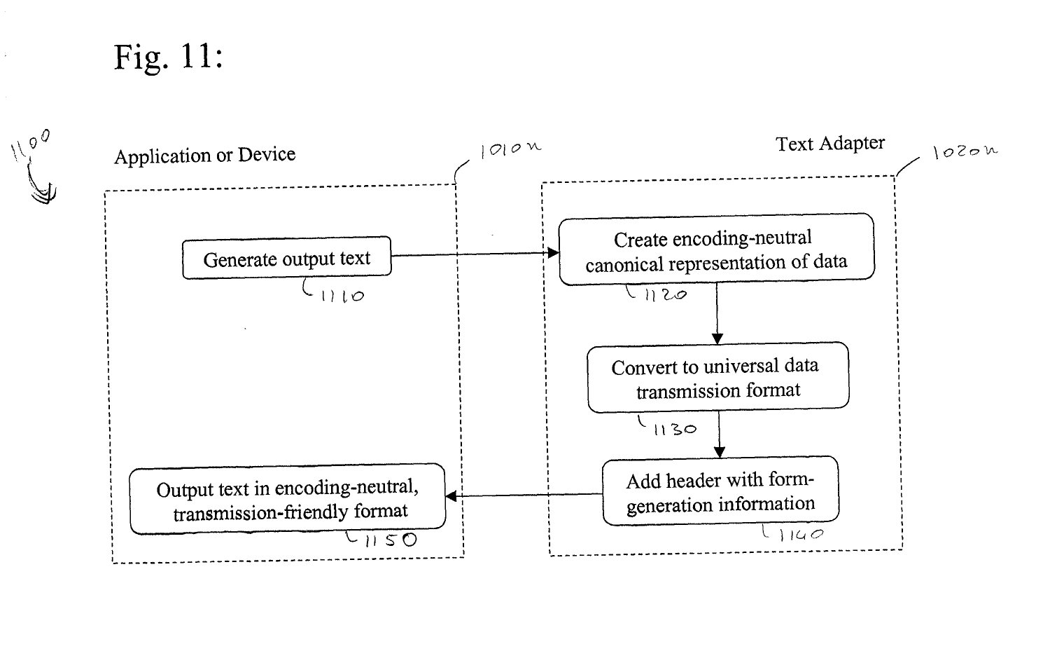

FIGS. 10 and 11 describe how client computer program 125 correctly handles and manipulates text data regardless of the limitations imposed by the operating system or by the document-creation software. This processing is necessary because computer systems and applications impose certain limitations on the types of text data they are capable of handling. A machine translation system, however, must be prepared to handle many different character sets and provide text encoding flexibly. This is accomplished via specialized text data adapters 1020n (where n=A, B, C . . . ), which are used for all transmission (both synchronous and asynchronous) of text between applications 1010n and devices 1010n, applications 1010n and applications 1010n, and devices 1010n and devices 1010n. Text data adapters 1020n re-encode the text data in a platform-independent manner and transmit that re-encoded information as a protected canonical data type. FIG. 10 shows the overall architecture of this system.

FIG. 11 describes a process 1100 through which a text adapter 1020n prepares text output from an application 1010n or device 1010n for safe transmission, regardless of the encoding limitations of the operating system or receiving application or device. First, the transmitting application or device sends a request to text adapter 1020n (stage 1110), where the request consists of the original text data and the name or ID of the encoding used in the original text data. The request may also specify the canonical form convention that text adapter 1020n should use to generate the output data.

Text adapter 1020n creates an encoding-neutral canonical representation of the original text data (stage 1120) by first converting the text data to a base universal encoding, such as UTF-16 or any other base universal encoding. Then the encoding-neutral canonical representation is converted to a universal data transmission format (stage 1130), such as ASCII, using a general binary-to-transmission-format encoding scheme, such as base-64 encoding. This transmission-friendly form of the encoding-neutral representation is then prefixed with a header that indicates the form used to generate the data (stage 1140). The text adapter then returns this header-prefixed data to the transmitting application 1010n or device 1010n (stage 1150), which can then safely transmit the data.

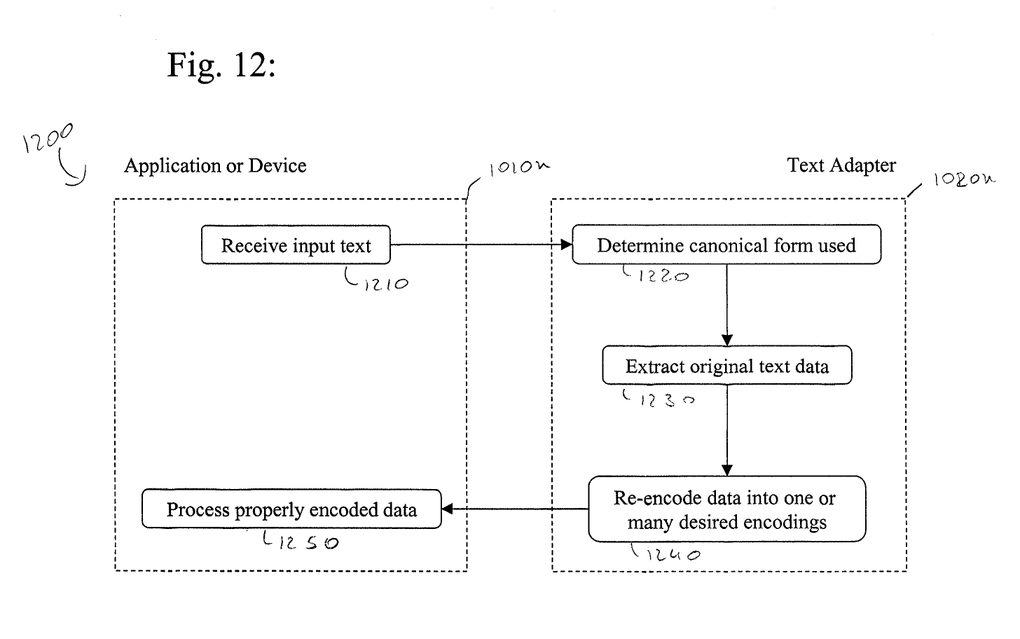

FIG. 12 describes a process 1200 through which a text adapter 1020n prepares text input received by an application 1010n or device 1010n for proper processing by the application 1010n or device 1010n, regardless of the encoding limitations of the operating system, application, or device, and without losing any information about the original text. First, the receiving application 1010n or device 1010n receives some text input in an encoding-neutral, transmission-friendly format (stage 1210). Application/device 1010n, in turn, sends a request to text adapter 1020n, where the request consists of the canonical representation of the text data and the one or many desired text character encoding for the text. Upon receipt, text adapter 1020n examines the canonical representation and determines the canonical form used (stage 1220). Text adapter 1020n then extracts the original text data (in the base universal text encoding) using that information (stage 1230). Text adapter 1020n, in turn, re-encodes the extracted text data into one of the target text encoding specified in the request and returns that re-encoded data to the host application (stage 1240). The re-encoded data can then be processed by application/device 1010n (stage 1250).

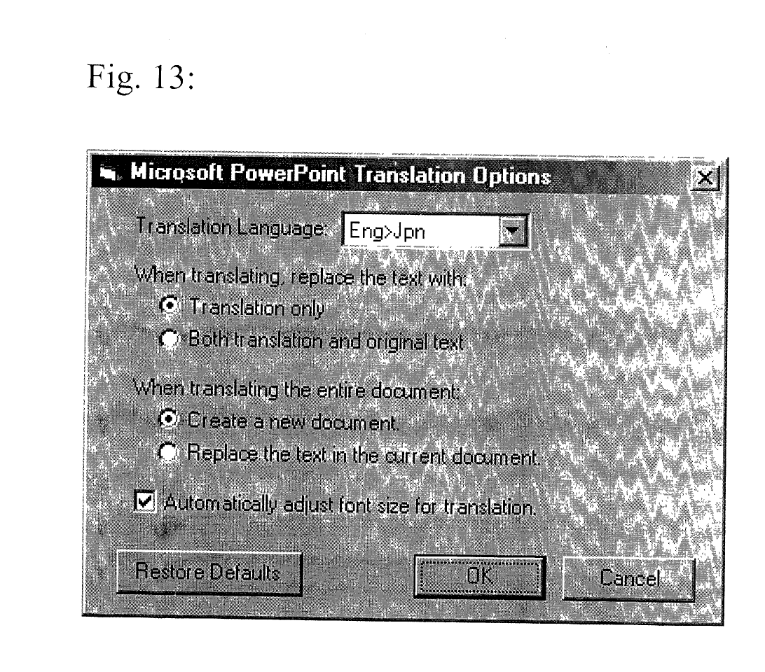

FIG. 13 is a screenshot of a translation destination window 1300, in accordance with some illustrative embodiments of the invention. By selecting options listed on translation destination window 1300, the user is able to select the destination of the translation result of a translation request. During the translation process, the user is queried for a translation destination, and the system sends the translation to the appropriate destination. Possible translation destinations include the end of the original source text document, the clipboard, a new document, or an attachment to a document.

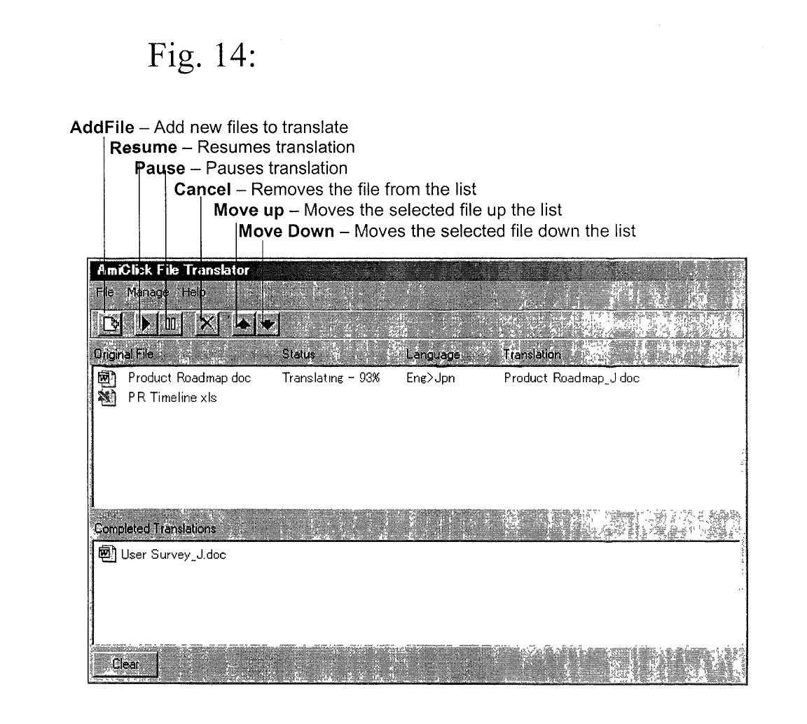

FIG. 14 is a screenshot of a translation job queue window 1400, in accordance with some illustrative embodiments of the invention. Translation job queue window 1400 shows the printing queue for a user using the translation service. When a translation request is made, the document enters the queue at an appropriate location. When the translation service is ready to service a request, it pulls a document from the queue from an appropriate location. When a document translation is completed, the document is either returned to the queue, marked as completed, or is returned to a separate list of completed translations. While a document is queued, the user can use the queue to raise or lower the priority of the document's translation. While a document is being translated, the user can use the queue to suspend the document's translation and reinsert the document into the queue. After a document translation has been completed, a user can use the queue or the completed translation list to request that the document be opened with an appropriate application.

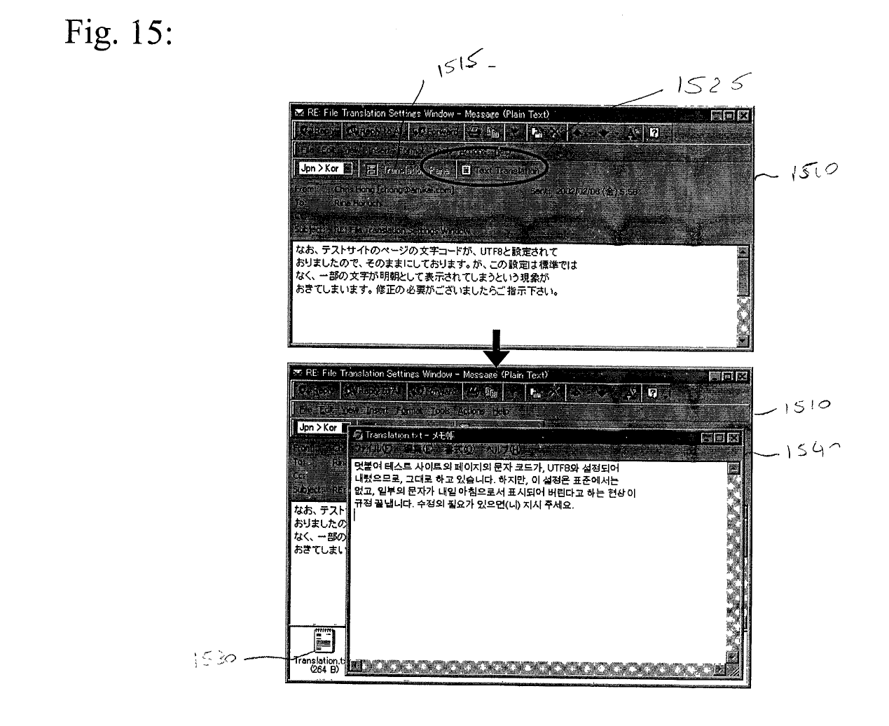

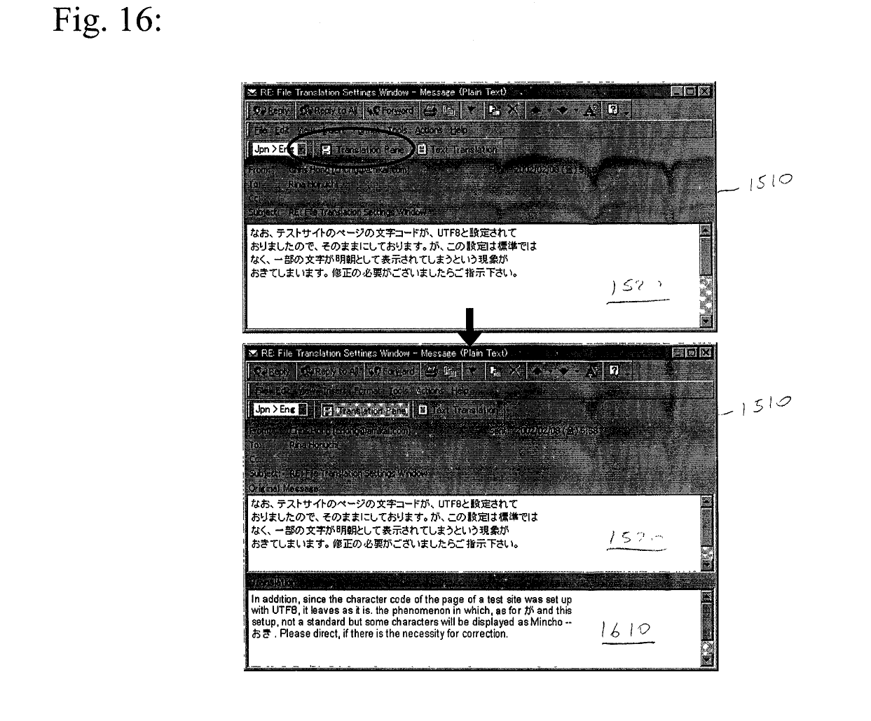

FIGS. 15-16 are screenshots illustrating elements of an email plug-in user interface for incoming messages, in accordance with some exemplary embodiments of the invention. In particular, FIG. 15 shows how the user can select the destination of the translation of an incoming email message via translation pane button 1515 and text translation button 1525. If the user selects text translation button (FIG. 15) the translation is stored as an attachment 1530 to the incoming message, which conveniently binds the original 1510 and translated versions 1540 of the email message. Conversely, FIG. 16 shows the user's ability to toggle the display between showing the original alone and the original with the translation by selecting translation pane button 1515. In some embodiments of the translation service, the user could also be allowed to display only the translation of the email message 1610.

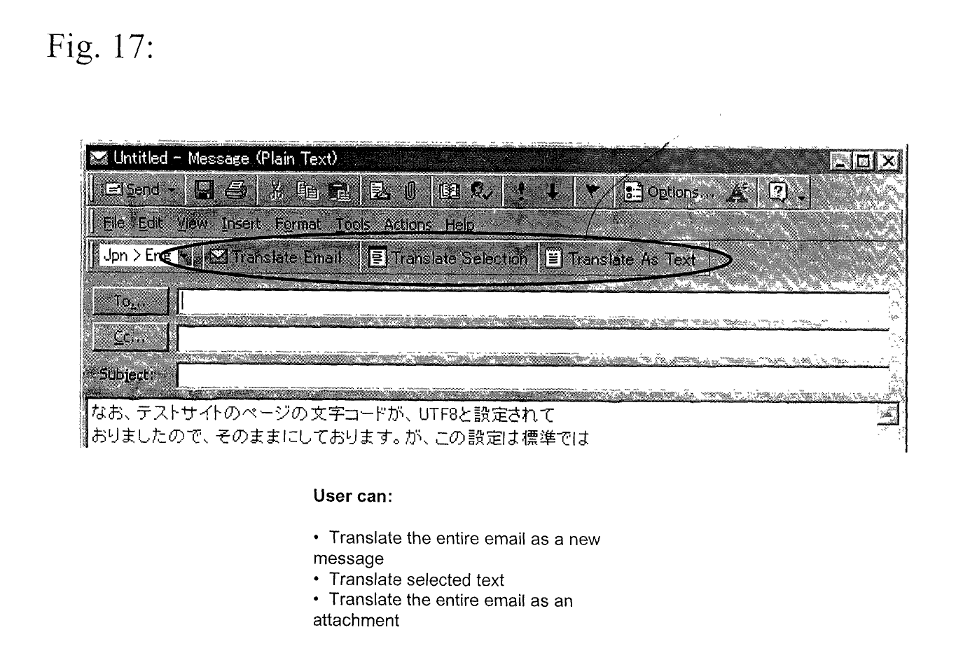

FIG. 17 shows the user's choices for the destination of the translation of an outgoing email message 1710. Exemplary translation destinations include a new email message, the end of the original message, or an attachment to the original message. The user is able to select among possible translation destination via buttons 1720.

Embodiments described above illustrate, but do not limit the invention. In particular, the invention is not limited to any specific hardware or software implementations. In fact, the system and method of the present invention can be implemented using any combination of hardware and/or software components, in accordance with the principles of the present invention. Other embodiments and varieties are within the scope of the invention, as defined by the following claims.

[image]

[image]

[image]

[image]

[image]

We claim:

1. A computer system comprising:
a server computer connected to one or more client computers via a distributed computer network; and
a server computer program executable by the server computer, the server computer program comprising computer instructions for:
generating a translated message in response to a request from a client computer program executable by the client computers to translate a universal data transmission formatted message;
wherein the client computer program comprises computer instructions for:
converting a text input into a base universal encoded message;
converting the base universal encoded message into the universal data transmission formatted message; and
prefixing the universal data transmission formatted message with a header indicating the base universal encoding and the universal data transmission format used to generate the message.

2. The computer system of claim 1, wherein the client computer program further comprises computer instructions for:
receiving a universal data transmission formatted message;
determining the universal data transmission format used to generate the universal data transmission formatted message;
extracting base universal encoded message from the universal data transmission formatted message; and
re-encoding the extracted base universal encoded message according to a target encoding.

3. A computer system comprising:
a server computer connected to one or more client computers via a distributed computer network; and
a server computer program executable by the server computer, the server computer program comprising computer instructions for:
generating a translated document in response to a request from a client computer program executable by the client computers;
wherein the client computer program comprises computer instructions for:
selecting a preferred destination for the translated document.

4. The computer of claim 3, wherein the preferred destination is selected from the group of:
appending to the original document;
writing into a new document;
sending to the clipboard; or
turning out to a user-specified destination.

5. A computer system comprising:
a server computer connected to one or more client computers via a distributed computer network; and
a server computer program executable by the server computer, the server computer program comprising computer instructions for:
generating a translated document in response to a request from a client computer program executable by the client computers;
wherein the client computer program comprises computer instructions for:
displaying a translation job queue window listing documents to be translated.

6. The computer system of claim 5, wherein the translated documents are marked as completed and listed in a separate section of the translation job queue window.

7. The computer system of claim 5, wherein translation jobs can be dynamically added to or delete from the translation job queue window.

8. The computer system of claim 5, wherein translation jobs can be suspended or reordered.

9. The computer system of claim 5, wherein completed translations can be directly opened from the translation job queue window.

10. A computer system comprising:
a server computer connected to one or more client computers via a distributed computer network; and
a server computer program executable by the server computer, the server computer program comprising computer instructions for:
generating a translated document in response to a request from a client computer program executable by the client computers to translate a target text document;
wherein the client computer program comprises computer instructions for:
receiving a translation request from an email computer program; and
sending the request to generate a translated email message to the server computer program.

11. The computer system of claim 10, wherein the client computer program further comprises computer instructions for:
selecting a destination for the translated email message.

12. The computer system of claim 10, wherein the client computer program further comprises computer instructions for:
attaching the requested translated email message to the untranslated email message.

13. The computer system of claim 10, wherein either the requested translation alone or the requested translation together with the untranslated email message are selectively displayed in a same window.

14. A method of performing automated machine translation, the method comprising:
converting a text input into a base universal encoded message;
converting the base universal encoded message into a universal data transmission formatted message;
prefixing the universal data transmission formatted message with a header indicating the base universal encoding and the universal data transmission format used to generate the message; and
generating a translated message in response to a request from a client computer program executable by the client computers to translate the universal data transmission formatted message;

15. The method of claim 14, further comprising:
receiving a universal data transmission formatted message;
determining the universal data transmission format used to generate the universal data transmission formatted message;
extracting base universal encoded message from the universal data transmission formatted message; and
re-encoding the extracted base universal encoded message according to a target encoding.

16. A method of performing automated machine translation, the method comprising:
generating on a server computer a translated document in response to a request from a client computer program executable by a client computer connected to the server computer via a distributed computer network; and
selecting a preferred destination for the translated document.

17. The method of claim 16, wherein the preferred destination is selected from the group of:
appending to the original document;
writing into a new document;
sending to the clipboard; or
turning out to a user-specified destination.

18. A method of performing automated machine translation, the method comprising:
generating on a server computer a translated document in response to a request from a client computer program executable by a client computer connected to the server computer via a distributed computer network; and
displaying a translation job queue window listing documents to be translated.

19. The method of claim 18, wherein the translated documents are marked as completed and listed in a separate section of the translation job queue window.

20. The method of claim 18, wherein translation jobs can be dynamically added to or delete from the translation job queue window.

21. The method of claim 18, wherein translation jobs can be suspended or reordered.

22. The method of claim 18, wherein completed translations can be directly opened from the translation job queue window.

23. A method of performing automated machine translation, the method comprising:
receiving a request to generate a translated email message to a server computer generate in response to a translation request from an email computer program; and
generating on a server computer a translated document in response to a request from a client computer program executable by a client computer connected to the server computer via a distributed computer network.

24. The method of claim 23, further comprising:
selecting a destination for the translated email message.

25. The method of claim 23, further comprising:
attaching the requested translated email message to the untranslated email message.

26. The method of claim 23, wherein either the requested translation alone or the requested translation together with the untranslated email message are selectively displayed in a same window.

27. A computer-readable storage medium storing a server computer program executable by a server computer connected to one or more client computers via a distributed computer network, the server computer program comprising computer instructions for:
generating a translated message in response to a request from a client computer program executable by the client computers to translate a universal data transmission formatted message;
wherein the client computer program comprises computer instructions for:
converting a text input into a base universal encoded message;
converting the base universal encoded message into the universal data transmission formatted message; and
prefixing the universal data transmission formatted message with a header indicating the base universal encoding and the universal data transmission format used to generate the message.

28. The computer-readable storage medium of claim 27, wherein the client computer program further comprises computer instructions for:
receiving a universal data transmission formatted message;
determining the universal data transmission format used to generate the universal data transmission formatted message;
extracting base universal encoded message from the universal data transmission formatted message; and
re-encoding the extracted base universal encoded message according to a target encoding.

29. A computer-readable storage medium storing a server computer program executable by a server computer connected to one or more client computers via a distributed computer network, the server computer program comprising computer instructions for:
generating a translated document in response to a request from a client computer program executable by the client computers;
wherein the client computer program comprises computer instructions for:
selecting a preferred destination for the translated document.

30. The computer-readable storage medium of claim 29, wherein the preferred destination is selected from the group of:
appending to the original document;
writing into a new document;
sending to the clipboard; or
turning out to a user-specified destination.

31. A computer-readable storage medium storing a server computer program executable by a server computer connected to one or more client computers via a distributed computer network, the server computer program comprising computer instructions for:
generating a translated document in response to a request from a client computer program executable by the client computers;
wherein the client computer program comprises computer instructions for:
displaying a translation job queue window listing documents to be translated.

32. The computer-readable storage medium of claim 31, wherein the translated documents are marked as completed and listed in a separate section of the translation job queue window.

33. The computer-readable storage medium of claim 31, wherein translation jobs can be dynamically added to or delete from the translation job queue window.

34. The computer-readable storage medium of claim 31, wherein translation jobs can be suspended or reordered.

35. The computer-readable storage medium of claim 31, wherein completed translations can be directly opened from the translation job queue window.

36. A computer-readable storage medium storing a server computer program executable by a server computer connected to one or more client computers via a distributed computer network, the server computer program comprising computer instructions for:
generating a translated document in response to a request from a client computer program executable by the client computers to translate a target text document;
wherein the client computer program comprises computer instructions for:
receiving a translation request from an email computer program; and
sending the request to generate a translated email message to the server computer program.

37. The computer-readable storage medium of claim 36, wherein the client computer program further comprises computer instructions for:
selecting a destination for the translated email message.

38. The computer-readable storage medium of claim 36, wherein the client computer program further comprises computer instructions for:
attaching the requested translated email message to the untranslated email message.

39. The computer-readable storage medium of claim 36, wherein either the requested translation alone or the requested translation together with the untranslated email message are selectively displayed in a same window.
